(19) United States
(12) Patent Application Publication
(10) Pub. No.: US 2002/0106428 A1
(43) Pub. Date: Aug. 8, 2002

(54) Disposable barbeque smoker

(76) Inventor: Jerzy Marek Szyjkowski, Caledon (CA)

Correspondence Address: Gifford, Krass, Groh, Sprinkle,, Anderson & Citkowski, P.C., Suite 400, 280 N. Old Woodward Avenue, Birmingham, MI, 48009-5393, US

(21) Appl. No.: 10/061,582

(22) Filed: Feb. 1, 2002

Related U.S. Application Data
(60) Provisional application No. 60/267,081, filed on Feb. 6, 2001.

(51) Int. Cl. A23B 4/00

(52) U.S. Cl. 426/113

(57) ABSTRACT

A disposable smoking device for smoking food on a barbeque grill includes a container section made of aluminum or aluminum alloy foil and comprising a bottom and a sidewall extending around this bottom and forming a rim. The device includes a cover section made of aluminum foil and connected to the rim. The container section and the cover section together form a substantially enclosed container having wood material therein. One or more small holes are formed in an exterior surface of this container to allow smoke to exit therefrom. In a preferred embodiment, each of the container section and the cover section has the shape of a standard, disposable tart pan.

### PRIOR APPLICATIONS

This application is based on and claims domestic priority from U.S. provisional application Serial No. 60/267,081 filed Feb. 6, 2001.

### BACKGROUND OF THE INVENTION

This invention relates to devices and equipment for enhancing the taste of food by means of a smoking process.

It is well known that the taste of food, particularly meat, can generally be enhanced or improved by a smoking process wherein a wood material, such as wood or wood chips, is used to generate the desired smoke for the process. A variety of equipment has been developed and is known for carrying out a smoking process, particularly for a commercial or large scale smoking operation. For example, recent U.S. Pat. No. 5,967,027, issued Oct. 19, 1999, describes and illustrates a smoking apparatus that includes a smoking chamber for containing the food material and a smoke or liquid smoke supply generator connected to the chamber for feeding the smoke or liquid smoke into the chamber. This apparatus is relatively complex, requiring a control device that is programmed to operate a vacuum pump and to operate the smoke supplying generator.

Earlier U.S. Pat. No. 4,270,464 issued Jun. 2, 1981 also describes a smoke generator for smoking food products, particularly meat. The smoke is produced from flowing sawdust maintained at a temperature just below the flame point in the presence of excess oxygen. Again, this machine is fairly complex and does not appear to be suitable for use by an ordinary consumer of smoke meat products.

Cooking food outdoors on a barbeque grill has been carried out for many years. In recent years, in order to make these grills easier to operate by a home user and in order to avoid the necessity of obtaining suitable charcoal, it has been common to employ barbeque units that rely upon propane or natural gas for the source of fuel. These barbeque units are quite easy to operate and they tend to be cleaner to operate and maintain. However, this convenience has come at the cost of compromising on the taste and aroma of the grilled food. It is generally recognized that burning wood charcoal in a barbeque creates a desired, natural scent which can improve the aroma and taste of the grilled food.

One way in which this taste problem has been addressed is by the use of a reusable metal container consisting of a main container portion with an open top and a removable lid for covering the top of the container. The lid may have holes formed therein. A person wishing to use such a container is able to fill the container with wood chips prior to starting the barbeque cooking process and the filled container is placed on the heat distributor of the barbeque unit, commonly lava rocks. Although these known metal containers can provide the necessary smoke for enhancing the flavour of the meat being cooked on the barbeque, these containers do suffer from certain deficiencies. After one use of the container in a barbeque unit, in order to reuse this smoking device again, it is necessary to refill the container with wood chips. To do this, the user must handle the dirty container which can be quite greasy and covered with tar and other undesirable material. The lid must be removed and the container handled so as to dispose of the wood ashes in the container and then to fill up the container with new wood chips.

It is an object of the present invention to provide an inexpensive, disposable smoking device for smoking food in the form of an enclosed container having wood material therein.

It is a further object of the present invention to provide a disposable smoking device that can be made quickly and easily with readily available materials and that can be used in a standard barbeque grill unit while food is being cooked thereon.

### SUMMARY OF THE INVENTION

According to one aspect of the invention, a disposable smoking device for smoking food comprises a substantially enclosed container made of a suitable, thin, non-combustible, metallic foil material and forming a wood containing chamber. An exterior surface of the container has one or a limited number of small holes formed therein to allow smoke to exit from the container during use of the smoking device. Wood material fills a substantial portion of the wood containing chamber.

Preferably the container is made of aluminum foil or aluminum alloy foil and includes a main container section and a cover section connected to the container section in a substantially airtight manner.

According to another aspect of the invention, a disposable smoking device for smoking food includes a container section made of aluminium foil or an aluminium alloy foil and comprising a bottom portion and a container side wall extending around this bottom portion and forming a rim. There is also a cover section made of aluminium foil or aluminium alloy foil and connected to the rim. The container section and the cover section together form a substantially enclosed container in which there is wood material. One or more small holes are formed in an exterior surface of the container to allow smoke to exit from the container during use of the smoking device.

In one preferred embodiment, the cover section is formed with a planar top portion and a cover sidewall extending downwardly from this top portion and around the perimeter of the top portion.

Further features and advantages will become apparent from the following detail description taken in conjunction with the accompanying drawings.

### BRIEF DESCRIPTION OF THE DRAWINGS

FIG. 1 is a side view of a preferred embodiment of the smoking device of the invention;

FIG. 2 is a top view of the preferred embodiment of FIG. 1;

FIG. 3 is a perspective view of the preferred smoking device;

FIG. 4 is a cross-sectional view of the preferred smoking device, this view being taken along the line IV-IV of FIG. 2;

FIG. 5 is a perspective view of a second embodiment having a flat cover section; and

FIG. 6 is a perspective view of a third embodiment of a smoking device made with metal foil.

### DETAILED DESCRIPTION OF PREFERRED EMBODIMENTS

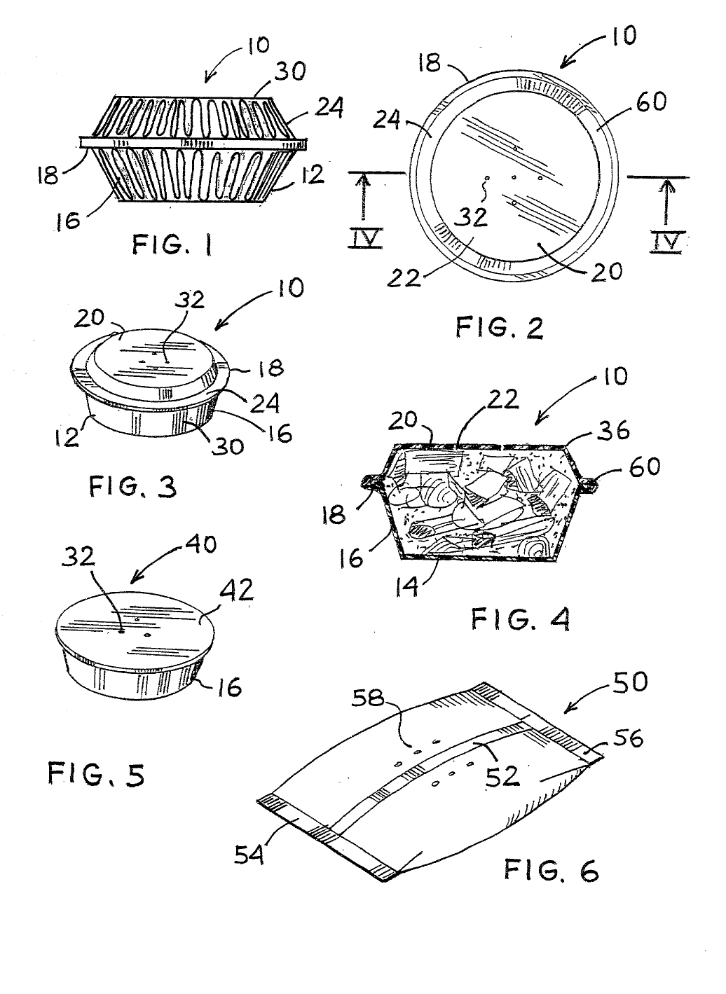

FIGS. 1 to 4 illustrate a preferred form of disposable smoking device 10 for smoking food, particularly meat and fish. This preferred device includes a main container section 12 made of a suitable, thin, non-combustible metal foil material. This foil material must have sufficient strength and rigidity to maintain its general shape and to hold and contain the wood material contained within the smoking device. The foil material preferably is non-toxic to humans and to food and will not generate toxic fumes or gases when subjected to the high temperatures generated by a barbeque unit. The preferred foil material is aluminium foil or an aluminium alloy foil which is relatively inexpensive and is commonly used in the cooking of foods. The illustrated preferred container section has a bottom portion or bottom wall 14 and a container sidewall 16 which extends around the bottom portion and preferably forms an outwardly projecting rim 18. The preferred smoking device also has a cover section 20 also made of aluminium foil or aluminium alloy foil and connected to the aforementioned rim 18. The container section 12 and the cover section 20 together form a substantially enclosed container. In this regard, it should be noted that the joint formed where the cover section 20 meets the rim of the container section is preferably and substantially air tight so that flames and hot gases cannot enter through the annular joint.

The preferred cover section 20 has a planar, circular top portion 22 and a cover side wall 24 extending downwardly from the top portion and around the perimeter of the top portion. It will thus be seen that in the preferred embodiment of FIGS. 1 to 4, each of the container section and the cover section has a shape corresponding substantially to a standard, disposable tart pan for a single tart. In fact, it is possible to construct the smoking device of FIGS. 1 to 4 using readily available tart pans that can be purchased from manufacturers of aluminium foil products. Moreover, one can construct both the container section and the cover section 24 using tart pans of a size currently manufactured for tart pan purposes. Although it is possible to make the container section and the cover section from tart pans of the same size, in a particularly preferred embodiment of the smoking device, the container section 12 is made from a tart pan that is slightly larger in size both with respect to its diameter and its depth than the tart pan which can form the cover section 20. For example, in one particular preferred embodiment of the smoking device, the container section 12 is made from a standard tart pan having a maximum, exterior diameter at the top of about 4 3/16 the inches and a depth of about ⅞th inch while the cover section has a maximum exterior diameter of about 4 inches and a depth of about ¾ inch. It will be understood that typically the sidewalls of these tart pans are formed with corrugations 30 that extend about the circumference of the side wall and that add strength and rigidity to the side wall.

One or more small holes 32 are formed in an exterior surface of the container to allow a limited amount of air to enter the container and to allow smoke to exit from the container during use of the smoking device 10. The preferred location for these holes 32 is in the cover section, more preferably in the central region of the cover section. This allows the smoke to readily escape upwardly to the meat located above the smoking device on the grill and also tends to help prevent ignition of the wood material in the container by the flames of the barbeque grill. The number of holes is preferably limited because this will also help to prevent ignition and flaming of the wood material in the container and it also limits the intake of oxygen into the container. It will be appreciated that an excessive amount of oxygen entering the container is undesirable as this will promote undesirable burning of the wood material by means of a flame.

FIG. 4 illustrates the use of wood material in the container. The preferred wood material comprises small wood chips 34 but it is also possible to use wood sawdust or a combination of wood chips and wood sawdust. The use of wood sawdust in the container is illustrated at 36. In a preferred embodiment of the smoking device, the wood chips fill at least a substantial portion of the enclosed container. In a particularly preferred embodiment, the wood material or wood chips fill at least a major portion of the container as shown in FIG. 4. It is recognized in the wood smoking art that some woods are better than others for food smoking purposes. The preferred wood chips are those produced from hickory or mesquite wood. It is also possible to incorporate into the wood material a liquid known as liquid wood smoke, if desired, and this material can be absorbed into the wood chips or wood saw dust. The use of this liquid smoke material is described in the aforementioned U.S. Pat. No. 5,967,027.

A second embodiment of a disposable smoking device is illustrated in FIG. 5. This smoking device 40 is similar to the smoking device of FIGS. 1 to 4 except that its covered section 42 is a planar foil sheet whose perimeter is connected in a substantially airtight manner to the rim of the container sidewall 16. Preferably the outwardly extending rim of the main container section in this embodiment is rolled back over the edge of the cover section 42 in order to hold the cover section tightly in place. This rim rolling process can be carried out quickly and easily using known, foil forming techniques. It will be appreciated that with this embodiment and assuming the same external diameter of the device, the embodiment of FIG. 5 will generally hold less wood material than that of FIG. 1. Of course, the amount of wood material in this embodiment can be increased by increasing the depth of the main container section. In the illustrated smoking device 40, the planar lid is formed with three small holes 32 in a central section thereof. These holes can be formed by a simple hole punch.

A third embodiment of a disposable smoking device is illustrated in FIG. 6 and this smoking device 50 comprises a sealed bag made from non-combustible metallic foil, preferably aluminum or aluminum alloy foil. Opposite longitudinal edge sections of a single foil sheet can be bent over and then the longitudinal edges sealed together at longitudinally extending joint 52. One end of the flattened tube at 54 can be sealed and then wood material inserted into the bag before the opposite end at 56 is sealed. One or more holes 58 can be formed in one side of this sealed bag to allow the smoke to escape when the device is used. Again, the foil material must be of a thickness and quality sufficient to contain the wood material during movement and during use of the smoking device.

Although the preferred disposable smoking device of the invention as shown in FIGS. 1 to 4 is round in plan view, it will be appreciated that other shapes are also possible. In the embodiment of FIGS. 1 and 4, both the bottom portion 14 and the top portion 22 are circular in shape as are the rims where the two sections 12 and 20 meet and are connected. However, it will be understood that a rectangular smoking device or an oval shaped smoking device is also possible and is within the scope of the present invention. In the case of a rectangular device, the flat bottom portion and the flat top portion are rectangular or square but the overall size of this device can be similar to the circular, illustrated device, that is, it can contain a similar amount of wood material. The preferred, circular device is relatively small, having a diameter not exceeding 7 inches, more preferably, a diameter of about 4 inches.

In the preferred embodiment of FIGS. 1 to 4, it will be seen that the cover section 20, which is the shape of a tart pan, has an outwardly projecting rim 60 that is formed around the perimeter of the cover sidewall at a bottom edge thereof. The rim 18 of the container section is firmly attached to the rim of the cover section by a foil rolling or crimping step which can be carried out in a manner known per se in the art of metal foil products.

It will be understood that the smoking device of the invention can be used in a conventional barbeque grilling unit by placing it on the heat distributor of the grill. In many cases, this heat distributor is in the form of a layer of lava rock. Because the smoking device is preferably small, it does not have a substantial weight and it can readily be moved over the lava rock or other type of heat distributor if desired during the cooking process. Thus, the smoking device can be exposed to the different temperatures existing in the middle and on the side of the grill and this in turn provides some control over the intensity of the smoking action. After the cooking is finished and after the smoking device has become cold to touch, the device containing the wood ashes can be conveniently and easily disposed of.

It will be readily apparent to those skilled in the art that various modifications and changes can be made to the smoking devices described herein without departing from the spirit and scope of this invention. Accordingly, all such modifications and changes as fall within the scope of the appended claims are intended to be part of this invention.

1. A disposable smoking device for smoking food comprising:
a container section made of aluminum foil or an aluminum alloy foil and comprising a bottom portion and a container sidewall extending around said bottom portion and forming a rim;
a cover section made of aluminum foil or aluminum alloy foil and connected to said rim, said container section and said cover section together forming a substantially enclosed container; and
wood material in said container,
wherein one or more small holes are formed in an exterior surface of said container to allow smoke to exit from the container during use of said smoking device.

2. A disposable smoking device according to claim 1 wherein said cover section is formed with a planar top portion and a cover sidewall extending downwardly from said top portion around the perimeter of said top portion.

3. A disposable smoking device according to claim 2 wherein each of said container section and said cover section has a shape corresponding substantially to a standard disposable tart pan for a single tart.

4. A disposable smoking device according to claim 2 wherein both said bottom portion and said top portion are circular in shape.

5. A disposable smoking device according to claim 2 wherein said cover section has an outwardly projecting rim formed around the perimeter of said cover sidewall at a bottom edge thereof and said rim of the container sidewall is firmly attached to said rim of the cover section by a foil rolling step.

6. A disposable smoking device according to claim 2 wherein said one or more holes are formed in said planar top portion of the cover section.

7. A disposable smoking device according to claim 1 wherein said wood material comprises wood chips which fill at least a substantial portion of the enclosed container.

8. A disposable smoking device according to claim 1 wherein said cover section is a planar foil sheet, the perimeter of said planar foil sheet being connected in a substantially airtight manner to said rim of the container sidewall.

9. A disposable smoking device according to claim 3 wherein said wood material consists of wood chips or sawdust.

10. A disposable smoking device according to claim 1 wherein said wood material includes liquid wood smoke absorbed into wood chips or wood sawdust.

11. A disposable smoking device for smoking food comprising:
a substantially enclosed container made of a suitable, thin , non-combustible metallic foil material and forming a wood containing chamber, an exterior surface of said container having one or a limited number of small holes formed therein to allow smoke to exit from the container during use of the smoking device; and
wood material filling a substantial portion of said wood containing chamber.

12. A disposable smoking device according to claim 11 wherein said container is made of aluminum foil or aluminum alloy foil.

13. A disposable smoking device according to claim 12 wherein said container includes a main container section providing a container bottom and a container sidewall extending around said container bottom and further includes a cover section connected to said container section in a substantially airtight manner.

14. A disposable smoking device according to claim 12 wherein said wood material comprises wood chips or wood sawdust and fills a major portion of said wood containing chamber.

15. A disposable smoking device according to claim 13 wherein said wood material consists of wood chips or sawdust.

16. A disposable smoking device according to claim 13 wherein each of said main container section and said cover section has a shape corresponding substantially to a tart pan for a single tart.

17. A disposable smoking device according to claim 11 wherein said container is a foil bag produced from a single, bent over foil sheet and sealed along opposite ends of said foil sheet.

18. A disposable smoking device according to claim 17 said container is formed by bending over opposite longitudinal edge sections of said foil sheet and then sealing together longitudinal edges of said foil sheet.

19. A disposable smoking device for smoking food on a barbeque grilling unit, said smoking device comprising:
a substantially enclosed container made of aluminum or aluminum alloy foil and forming a relatively small wood containing chamber, an exterior wall of said container having one or a limited number of small holes formed therein to allow smoke to exit from said chamber during use of the smoking device; and
wood material selected from the group comprising wood chips and wood sawdust filling a substantial portion of said wood containing chamber.

20. A disposable smoking device according to claim 19 wherein said container is substantially round in a top view and has a diameter not exceeding seven inches.

21. A disposable smoking device according to claim 19 wherein said container includes a main container section having a shape corresponding to a tart pan for a single tart and further includes a cover section connected to said container section in a substantially airtight manner.
